(19) United States
(12) Patent Application Publication
(10) Pub. No.: US 2026/0099418 A1
(43) Pub. Date: Apr. 9, 2026

(54) INFORMATION PROCESSING SYSTEM AND INFORMATION PROCESSING METHOD

(71) Applicant: Hitachi, Ltd., Tokyo (JP)

(72) Inventors: Yuichi KITAGAWA, Tokyo (JP); Takahito TANIMURA, Tokyo (JP); Masayuki TAKASE, Tokyo (JP); Shinichi OKAMOTO, Tokyo (JP); Yusuke MORIYAMA, Tokyo (JP)

(21) Appl. No.: 19/229,337

(22) Filed: Jun. 5, 2025

(30) Foreign Application Priority Data
Oct. 7, 2024 (JP) 2024-176155

(51) Int. Cl. G06F 11/34

(52) U.S. Cl. CPC G06F 11/3409

(57) ABSTRACT

An information processing system selects a valid trained model candidate from trained models and presents the selected trained model candidate to a model user. A model user calculation device calculates a model application target data feature that is a feature of model application target data which is an application target of the trained model candidate. A model management server calculates a similarity between a model pre-evaluation data feature that is a feature of model pre-evaluation data for pre-evaluating performance of the trained model candidate and the model application target data feature. Then, the model management server calculates a score for predicting validity of the trained model candidate based on the similarity and model pre-evaluation accuracy that is model accuracy of a trained model pre-evaluated based on the model pre-evaluation data. Then, the model management server presents the score together with the trained model candidate to the model user.

### CROSS-REFERENCE TO RELATED APPLICATION

The present application claims priority from Japanese application JP2024-176155, filed on Oct. 7, 2024, the content of which is hereby incorporated by reference into this application.

### BACKGROUND OF THE INVENTION

### 1. Field of the Invention

The present invention relates to an information processing system and an information processing method.

### 2. Description of Related Art

Machine learning is one of techniques for implementing artificial intelligence (AI). The machine learning technique includes a learning process and a prediction process. The learning process calculates a learning parameter so as to minimize an error between a predicted value obtained from an input feature vector and an actual value (true value). The prediction process calculates a new prediction value from data that is not used for learning.

It is possible to promote digital transformation (DX) in a company such as sales prediction and sales support by applying AI to sales data and customer data on business. On the other hand, in a case where the machine learning is started from the beginning, there may be no human resource having a skill of machine learning at the site, or costs of model training or time costs of data collection may increase, and thus a chance to utilize the machine learning is limited.

Therefore, as a method for providing a chance to utilize machine learning, for example, Patent Literature 1 discloses an information processing device in which a model user can select and use a desired trained model from a plurality of trained models generated by a model developer.

### CITATION LIST

### Patent Literature

Patent Literature 1: JP2023-151913A

### SUMMARY OF THE INVENTION

However, in Patent Literature 1, a model desired by the model user is searched using sample data or simulation data for model performance evaluation. There is a problem in that a risk of leakage of sensitive information is caused by transmitting the sample data or the simulation data to a search server.

The invention has been made in view of the above circumstances, and an object of the invention is to reduce a risk of leakage of sensitive information when a model user searches for a desired model.

A representative example of the invention disclosed in the present application is as follows. An information processing system that selects a valid trained model candidate from a plurality of trained models and presents the selected trained model candidate to a model user is provided. The information processing system includes a model management server, and a model user calculation device configured to be operated by the model user. The model management server stores, in a storage unit, the plurality of trained models, a model pre-evaluation data feature that is a feature of model pre-evaluation data for pre-evaluating performance of the plurality of trained models, and model pre-evaluation accuracy that is model accuracy of the plurality of trained models pre-evaluated based on the model pre-evaluation data. The model user calculation device stores, in a storage unit, model application target data that is an application target of the trained model candidate selected from the plurality of trained models, calculates a model application target data feature that is a feature of the model application target data, and transmits the calculated model application target data feature to the model management server. The model management server calculates a similarity between the model pre-evaluation data feature and the model application target data feature received from the model user calculation device, calculates a score for predicting validity of the trained model candidate based on the similarity and the model pre-evaluation accuracy, and presents the score together with the trained model candidate to the model user via the model user calculation device.

According to the invention, it is possible to reduce a risk of leakage of sensitive information when a model is provided from a model provider to a model user.

### BRIEF DESCRIPTION OF THE DRAWINGS

FIG. 1 is a diagram illustrating an example of an overall configuration of a model search system.

FIG. 2 is a diagram illustrating a configuration example of a model provider calculation device and a model provider operation terminal.

FIG. 3 is a diagram illustrating an example of a model upload interface.

FIG. 4 is a diagram illustrating an example of model meta information.

FIG. 5 is a diagram illustrating an example of a model management server.

FIG. 6 is a diagram illustrating an example of a model actual use DB.

FIG. 7 is a diagram illustrating an example of a model user calculation device and a model user operation terminal.

FIG. 8 is a diagram illustrating an example of a model search interface.

FIG. 9 is a diagram illustrating an example of a regression prediction accuracy calculation interface.

FIG. 10 is a diagram illustrating an example of a model user evaluation input interface.

FIG. 11 is a flowchart illustrating an example of model providing processing.

FIG. 12 is a diagram illustrating an example of a sequence from a model search to a model user evaluation input.

FIG. 13 is a flowchart illustrating an example of reference score calculation processing.

FIG. 14 is a flowchart illustrating an example of prediction accuracy calculation processing.

FIG. 15 is a diagram illustrating an example of hardware structure of a computer.

### DESCRIPTION OF EMBODIMENTS

Hereinafter, an embodiment of the invention will be described with reference to the drawings.

### (1) Overall Configuration of Model Search System 1

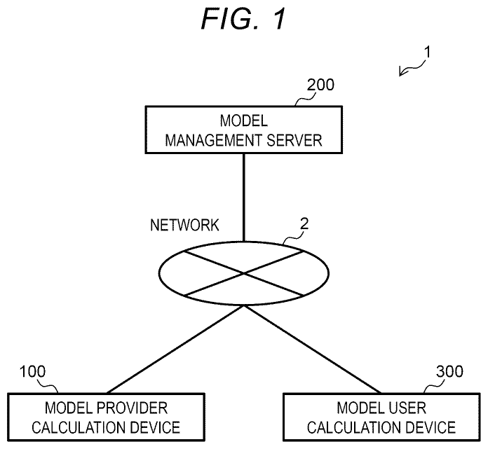

FIG. 1 illustrates an example of an overall configuration of a model search system 1. The model search system 1 is an example of an information processing system. The model search system 1 includes one or more model provider calculation devices 100, model user calculation devices 300, and model management servers 200, which are connected to one another via a network 2.

The model provider calculation device 100 is a calculation device operated by a model provider, transmits a trained model provided by the model provider to the model management server 200, and provides the trained model to a model user. The model user calculation device 300 is a calculation device operated by a model user who wants to use the trained model provided by a model provider. The model management server 200 stores the trained model provided by the model provider, searches for a trained model suitable for data attribute required by the model user at the time of a model search, and presents the trained model to the model user.

In the present embodiment, as illustrated in FIG. 1, a minimum configuration of the model search system 1 includes one model provider calculation device 100, one model user calculation device 300, and one model management server 200. However, the configuration of the model search system 1 is not limited thereto, and the entire model search system 1 may include at least one model provider calculation device 100, at least one model user calculation device 300, and at least one model management server 200.

### (2) Configuration of Model Provider Calculation Device 100 and Model Provider Operation Terminal 50

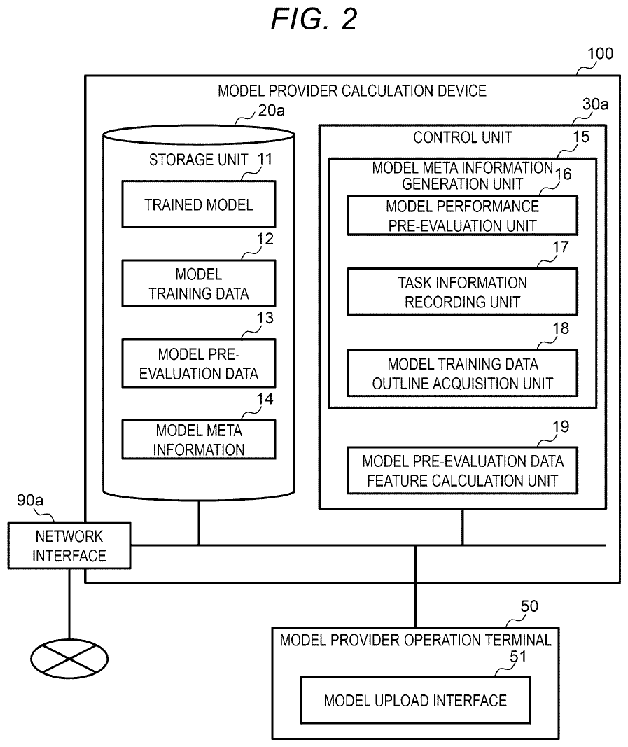

FIG. 2 is a diagram illustrating a configuration example of the model provider calculation device 100 and a model provider operation terminal 50. The model provider calculation device 100 includes a storage unit 20a and a control unit 30a. The storage unit 20a is connected to the control unit 30a using, for example, a magnetic disk as a storage medium.

The model provider calculation device 100 is connected to the model management server 200 via a network interface 90a. The storage unit 20a stores a trained model 11 including a plurality of trained models trained by a model provider and model training data 12 used to train the trained model 11. The storage unit 20a stores model pre-evaluation data 13 for pre-evaluating performance of the trained model 11, and model meta information 14 in which pre-evaluated performance, task information, and training data information of the trained model 11 are recorded.

The model provider operation terminal 50 is connected to the model provider calculation device 100. A model provider operates a model upload interface 51 of the model provider operation terminal 50 to transmit the trained model 11 from the model provider operation terminal 50 to the model provider calculation device 100.

The control unit 30a implements functions of the model provider calculation device 100 when the trained model 11 is transmitted to the model management server 200. The control unit 30a includes a model meta information generation unit 15 that generates the model meta information 14 corresponding to the trained model 11, and a model pre-evaluation data feature calculation unit 19 that calculates a feature of the model pre-evaluation data 13.

The “feature” referred to in the present embodiment is not limited to summary statistics, and includes a dimension reduction method by a principal component analysis (PCA) or the like, and neural net-based feature extraction such as autoencoder.

The model pre-evaluation data feature calculation unit 19 executes data protection and reduction by compressing or deforming data while maintaining properties of original data. The data protection and reduction include, for example, calculation of summary statistics such as an average, a variance, a minimum, a maximum, and a median of data, extraction of a latent representation of data using an autoencoder, and dimension reduction of data using a method such as principal component analysis.

The model meta information generation unit 15 includes a model performance pre-evaluation unit 16 that executes processing according to an operation on the model upload interface 51 by a model provider, a task information recording unit 17, and a model training data outline acquisition unit 18. When the trained model 11 is transmitted to the model management server 200, the model upload interface 51 is operated by the model provider to enable the model meta information generation unit 15 to execute processing.

The model performance pre-evaluation unit 16 evaluates the trained model 11 using the model pre-evaluation data 13 in advance before the trained model 11 is transmitted to the model management server 200, and records an evaluation result in the model meta information 14.

The task information recording unit 17 records, in the model meta information 14, model task information input in a natural language on the model upload interface 51 when the trained model 11 is transmitted to the model management server 200.

When the trained model 11 is transmitted, the model training data outline acquisition unit 18 acquires information on a data type and a data size of the model training data 12 used when the trained model 11 is trained, and records the information in the model meta information 14.

The model provider operation terminal 50 includes the model upload interface 51. The model upload interface 51 is used to input an operation when the model provider uploads the trained model 11 to the model management server 200.

### (3) Model Upload Interface 51

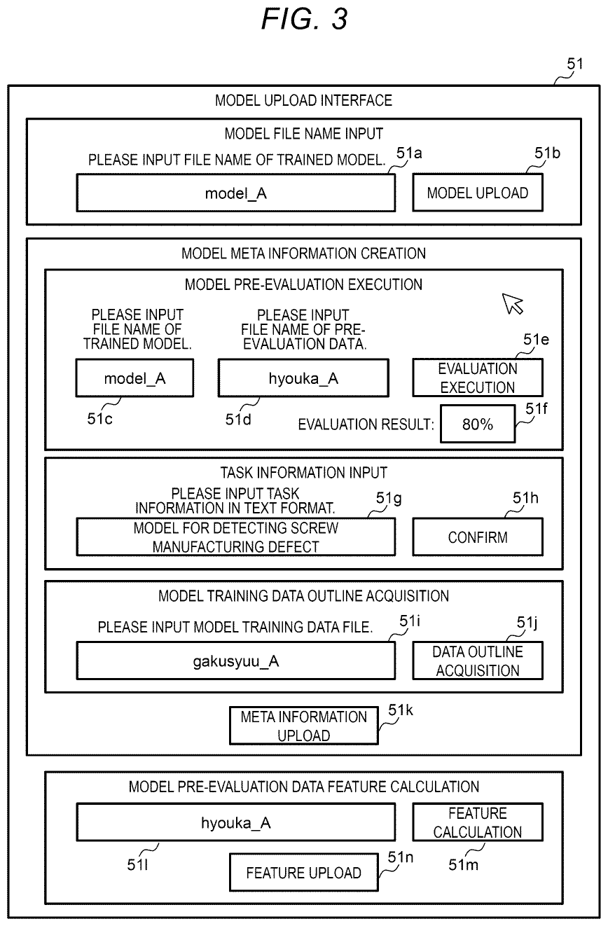

FIG. 3 is a diagram illustrating an example of the model upload interface 51. The model upload interface 51 is used to operate the model provider calculation device 100 when a model provider transmits the trained model 11 to the model management server 200.

The model provider inputs a model file name of the trained model 11 to a model file name input field 51a on the model upload interface 51. Thereafter, when a model upload button 51b is pressed by the model provider, the model is transmitted to the model management server 200.

The model provider inputs the model file name of the trained model 11 to a model file name input field 51c, and inputs a data file name of the model pre-evaluation data 13 used in evaluation of the trained model 11 to a data file name input field 51d. In this manner, the model meta information 14 corresponding to the trained model 11 is created. Then, the model provider presses an evaluation execution button 51e to execute pre-evaluation of the trained model 11. An evaluation result of the pre-evaluation is displayed in an evaluation result field 51f.

The model provider inputs model task information indicating the use of the trained model 11 in a natural language to a model task information input field 51g. Then, the model provider acquires model task information by pressing a confirmation button 51h.

The model provider inputs a file name of the model training data 12 in a file name input field 51i. Then, the model provider presses a data outline acquisition button 51j to acquire a data outline related to information of a data type and a data size.

After execution of the model pre-evaluation, input of the task information, and acquisition of the model training data outline described above are all executed, and the model provider presses a meta information upload button 51k to create the model meta information 14 and upload the created model meta information 14 to the model management server 200.

Further, the model provider inputs the data file name of the model pre-evaluation data 13 used in the model pre-evaluation to a data file name input field 511, and presses a feature calculation button 51m. Accordingly, processing of the model pre-evaluation data feature calculation unit 19 is executed, and a feature of the model pre-evaluation data 13 is calculated. The model provider presses a feature upload button 51n to transmit the calculated feature of the model pre-evaluation data 13 to the model management server 200.

### (4) Model Meta Information 14

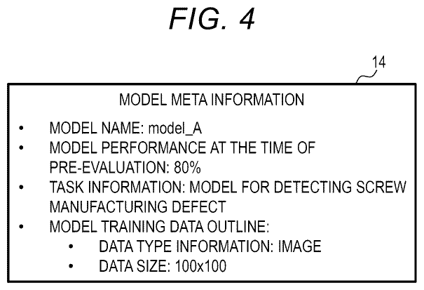

FIG. 4 is a diagram illustrating an example of the model meta information 14. The model meta information 14 is generated by the model provider operating the model upload interface 51 of the model provider operation terminal 50.

The model meta information 14 is referred to when a model user performs a model search. The model meta information 14 records a model name, model performance at the time of pre-evaluation calculated by a model provider, task information of a model input in a natural language, and a data type, a data size, and the like used when the trained model 11 is trained. The information recorded in the model meta information 14 according to the present embodiment is an example, and for example, information such as the number of pieces of data used at the time of training, a capacity of a trained model, and a computing environment in which the trained model 11 is trained may be recorded.

### (5) Configuration of Model Management Server 200

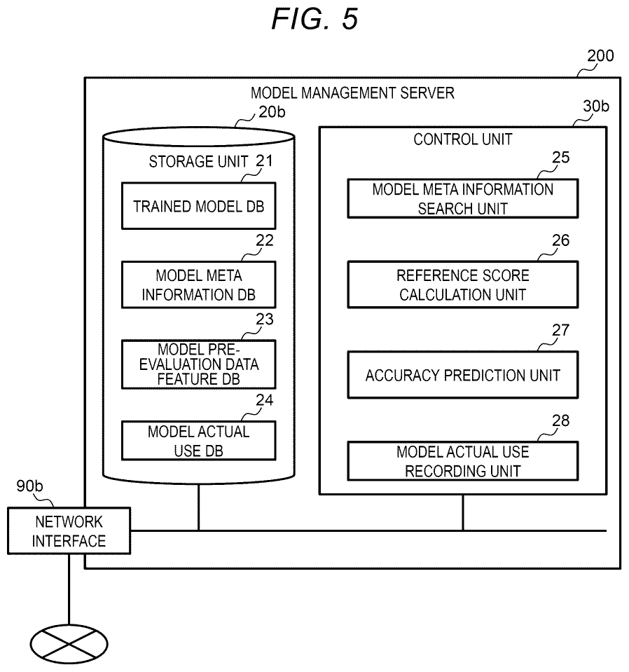

FIG. 5 is a diagram illustrating a configuration example of the model management server 200. The model management server 200 includes a storage unit 20b and a control unit 30b. The storage unit 20b is connected to the control unit 30b using, for example, a magnetic disk as a storage medium.

The model management server 200 is connected to the model provider calculation device 100 and the model user calculation device 300 via a network interface 90b. The storage unit 20b stores a trained model DB 21, a model meta information DB 22, a model pre-evaluation data feature DB 23, and a model actual use DB 24.

The trained model DB 21 stores the trained model 11 transmitted from the model provider. The model meta information DB 22 stores the model meta information 14 transmitted from the model provider. The model pre-evaluation data feature DB 23 stores the model pre-evaluation data feature transmitted from the model provider in association with the trained model 11.

The model actual use DB 24 records past model actual use data required for predicting accuracy of a model searched by a model user with respect to model application target data owned by the model user. The model actual use DB 24 stores a model name, pre-evaluation accuracy of a model, and a similarity between a model pre-evaluation data feature of a model provider and a model application target data feature of a model user in association with a record ID. Further, the model actual use DB 24 records accuracy when the trained model 11 searched and used by the model user is applied to the model application target data in association with a record ID.

The control unit 30b includes a model meta information search unit 25, a reference score calculation unit 26, an accuracy prediction unit 27, and a model actual use recording unit 28. The model meta information search unit 25 searches the model meta information DB 22 for a model that matches a model search requirement when a model user performs a model search. At the time of performing the model search, the model meta information search unit 25 calculates a similarity between task information recorded in the model meta information 14 and a search model task input by the model user at the time of the model search.

At the time of the model search by the model user, the reference score calculation unit 26 calculates a reference score indicating how effective a download candidate model matching a requirement of the model search is on the model application target data of the model user. The reference score is calculated by multiplying a similarity between a model pre-evaluation data feature and a model application target data feature by model pre-evaluation performance as in Formula (1). The similarity between the model pre-evaluation data feature and the model application target data feature is calculated by a similarity calculation function based on a cosine similarity, the Euclidean distance, the Manhattan distance, and the Chebyshev distance.

$$S = {R}_{( {f}_{p} , {f}_{u} )} \times MA \qquad ( 1 )$$

S: reference score
R: similarity calculation function
ƒₚ: model pre-evaluation data feature
ƒu: model application target data feature
MA: model pre-evaluation accuracy

The accuracy prediction unit 27 predicts model accuracy for the model application target data more precisely than the reference score in response to a request from the model user.

The prediction accuracy is calculated as in Formula (2) using a model pre-evaluation degree and the similarity between the model pre-evaluation data feature and the model application target data feature as variables.

A prediction accuracy calculation function, which is a prediction model in Formula (2), is determined using, for example, a multiple regression equation such as Formula (3). A similarity weight a, a model pre-evaluation accuracy weight b, and a correction term c in Formula (3) are determined by the following least-squares method. That is, in the least-squares method, the pre-evaluation accuracy of each trained model 11 recorded in the model actual use DB 24 and the similarity between the model pre-evaluation data feature of a model provider and the model application target data feature of a model user are used as explanatory variables. In the least-squares method, the pre-evaluation accuracy of the trained model 11 is used as an objective variable.

Although the multiple regression equation is exemplified as the prediction accuracy calculation function in the present embodiment, the prediction accuracy calculation function is not limited thereto. That is, a neural network model may be trained, and the trained model may be used as the prediction accuracy calculation function. In the neural network model, for example, prediction accuracy of the pre-evaluation accuracy of the trained model 11 is used as an objective variable, and the pre-evaluation accuracy of each trained model 11 and the similarity between the model pre-evaluation data feature of the model provider and the model application target data feature of the model user are used as explanatory variables.

$$P V = F ( {R}_{( {f}_{p} , {f}_{u} ) , M A} ) \qquad ( 2 )$$

PV: prediction accuracy
F: prediction accuracy calculation function

$${F}_{( {R}_{( {f}_{p} , {f}_{u} ) , MA} )} = {aR}_{( {f}_{p} , {f}_{u} )} + bMA + c \qquad ( 3 )$$

F: prediction accuracy calculation function
a: similarity weight
b: model pre-evaluation accuracy weight
c: correction term

The model actual use recording unit 28 evaluates a model downloaded by a model user using the model application target data when a model user evaluation result is transmitted from the model user. An evaluation result, a model name, a pre-evaluation accuracy of a model, and a similarity between the model pre-evaluation data feature of the model provider and the model application target data feature of the model user are recorded in association with a record ID.

### (6) Model Actual Use DB 24

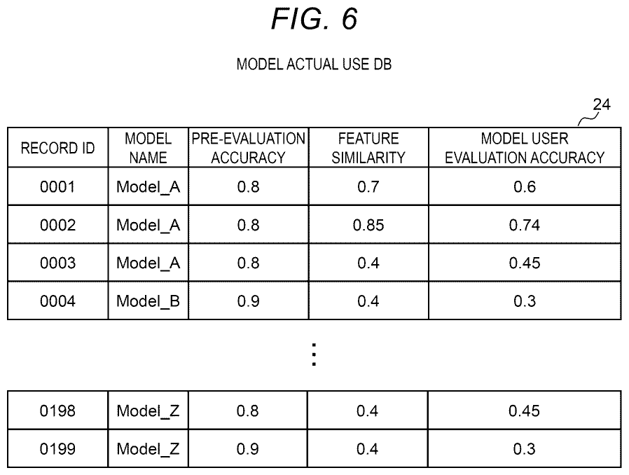

FIG. 6 is a diagram illustrating an example of the model actual use DB 24. The model actual use recording unit 28 records model actual use data in the model actual use DB 24 when the model user evaluation result is transmitted from the model user. The model actual use DB 24 stores the model name, the pre-evaluation accuracy of the model, and the similarity between the model pre-evaluation data feature of the model provider and the model application target data feature of the model user in association with the record ID. The model actual use DB 24 records the model user evaluation accuracy, which is a result of evaluating a model downloaded by the model user using the model application target data, in association with the record ID. The record ID is an ID in chronological order in which the model user searches for and downloads the trained model 11 and performs model evaluation. The recorded data is referred to when accuracy prediction is executed, and is used to derive a prediction accuracy calculation function such as a multiple regression equation.

### (7) Configuration of Model User Calculation Device 300 and Model User Operation Terminal 60

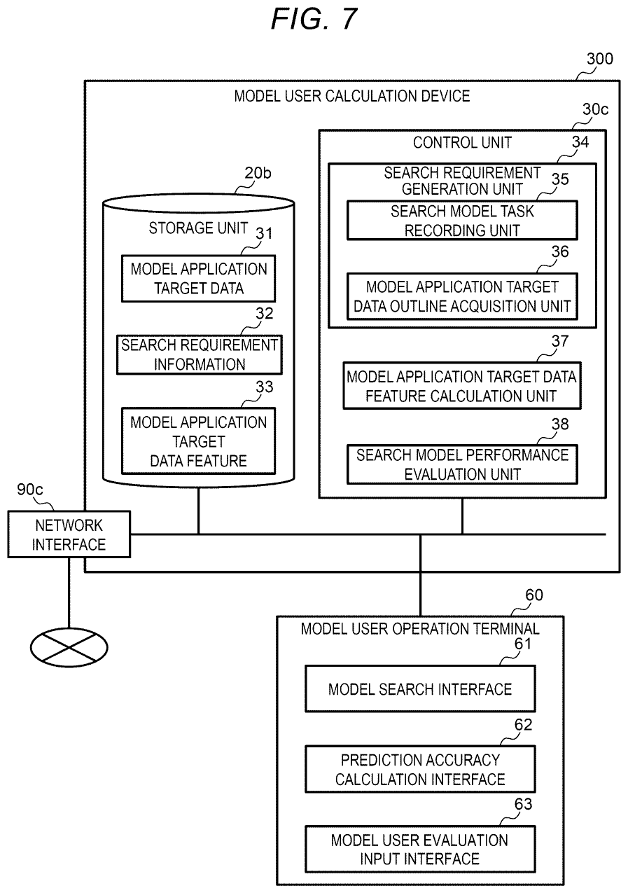

FIG. 7 is a diagram illustrating a configuration example of the model user calculation device 300 and a model user operation terminal 60. The model user calculation device 300 includes a storage unit 20c and a control unit 30c. The storage unit 20c is connected to the control unit 30c using, for example, a magnetic disk as a storage medium.

The model user calculation device 300 is connected to the model management server 200 via a network interface 90c. The model user operation terminal 60 is connected to the model user calculation device 300. The control unit 30c implements functions of the model user calculation device 300.

The storage unit 20a stores model application target data 31, search requirement information 32, and a model application target data feature 33. The model application target data 31 is data to be an application target to which a model searched by the model user and downloaded from the model management server 200 is applied, and is also used for evaluation of the trained model 11 downloaded by the model user.

The search requirement information 32 is generated when the model user searches for the trained model 11. At the time of a model search, a model is searched for using the model meta information 14 and the search requirement information 32. The model application target data feature 33 is calculated when the model search is executed.

The control unit 30c includes a search requirement generation unit 34, a model application target data feature calculation unit 37, and search a model performance evaluation unit 38.

The search requirement generation unit 34 generates the search requirement information 32 used for a model search by a model user. The search requirement generation unit 34 includes a search model task recording unit 35 and a model application target data outline acquisition unit 36.

The search model task recording unit 35 records, in the search requirement information 32, use of a search model input in the natural language when the model user searches for a model. The model application target data outline acquisition unit 36 acquires information on a data type and a data size of the model application target data 31 at the time of a model search, and records the acquired information in the search requirement information 32.

The model application target data feature calculation unit 37 calculates a feature of the model application target data 31 at the time of a model search according to a data protection and reduction method by compressing and deforming the data while maintaining properties of the original data. The data protection and reduction method include, for example, calculation of summary statistics such as a mean, a variance, a minimum, a maximum, and a median of data, extraction of a latent representation of data using an autoencoder, and dimension reduction of data using a method such as principal component analysis.

The search model performance evaluation unit 38 evaluates performance of the trained model 11 searched and downloaded by a model user. The search model performance evaluation unit 38 evaluates model accuracy of the downloaded trained model 11 based on the model application target data 31 using a known technique.

The model user operation terminal 60 includes a model search interface 61, a prediction accuracy calculation interface 62, and a model user evaluation input interface 63.

The model search interface 61 is used when a model user searches for a model. The prediction accuracy calculation interface 62 is used when the model user calculates a prediction accuracy of a searched model. The model user evaluation input interface 63 is used when the model user evaluates the trained model 11 searched and downloaded by the model user.

### (8) Model Search Interface 61

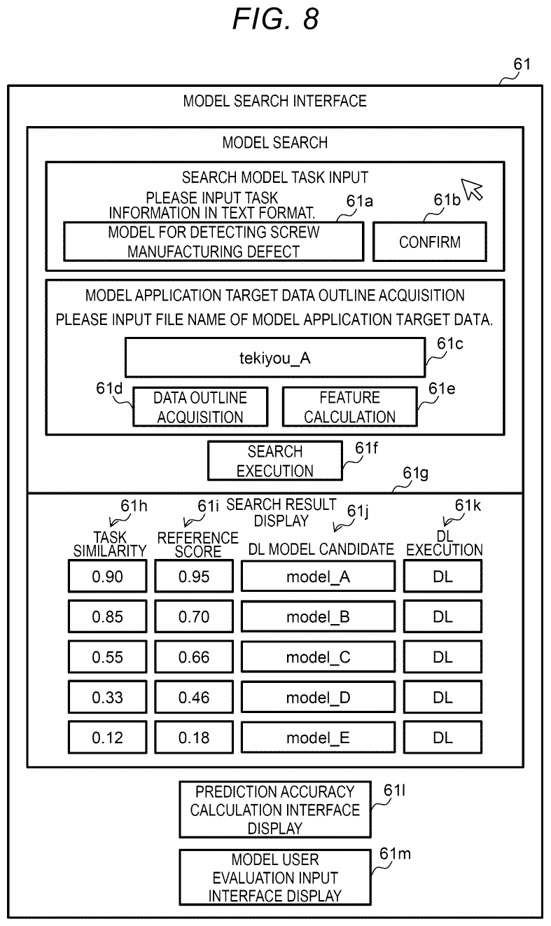

FIG. 8 is a diagram illustrating an example of the model search interface 61. The model search interface 61 is used when the model user searches for the trained model 11 stored in the model management server 200.

The model user uses the model search interface 61 to operate the model user calculation device 300 when a model is transmitted to the model management server 200. The model user inputs use of a model to be searched for as a search model task in the natural language in a task information input field 61a as a model search requirement. When a confirmation button 61b is pressed by the model user, the search model task input to the task information input field 61a is confirmed.

Further, when the model user inputs a file name of the model application target data 31 in a file name input field 61c and presses a data outline acquisition button 61d, a data outline regarding information of a data type and a data size of the model application target data 31 is acquired. Further, when the model user presses a feature extraction button 61e, the model application target data feature 33 of the model application target data 31 is calculated.

A search model task is input as a model search requirement, and data of the model application target data 31 is acquired. When a search execution button 61f is pressed after the model application target data feature 33 is calculated, the search requirement information 32 is generated, and model search is executed. A search result of the model search is displayed in a search result display field 61g of the model search interface 61.

In the model search, first, based on data type and data size information of the search requirement information 32, the model meta information 14 whose data type and data size information in the model meta information DB 22 on the model management server 200 matches with those of the search requirement information 32 is searched. Then, a model associated with the model meta information 14 whose data type and data size information matches those of the search requirement information 32 is extracted as a model matching a search requirement.

When the model is extracted, a similarity between task information described in the model meta information 14 of the extracted model and search model task information of the search requirement information 32 created at the time of the model search is calculated by, for example, the cosine similarity. The model search results are displayed in descending order of the calculated similarity values.

Further, a model pre-evaluation data feature associated with the extracted model is searched in the model pre-evaluation data feature DB 23. Then, a similarity between a model pre-evaluation data feature of the extracted model and the model application target data feature 33 calculated at the time of a model search is calculated by a similarity calculation function based on the cosine similarity, the Euclidean distance, the Manhattan distance, and the Chebyshev distance. A reference score is calculated by multiplying the calculated similarity between the features and a value of model performance at the time of pre-evaluation described in the model meta information 14 of the extracted model as in Formula (1) described above. The reference score is an example of a score for predicting validity of a candidate of a trained model.

Then, the task information described in the calculated model meta information 14, a task similarity 61h of the search model task information of the search requirement information 32 created at the time of the model search, and a reference score 61i are written together as a download candidate model 61j which is a model search result. The model user can start downloading a model suitable for the model application target data 31 by pressing a download execution button 61k based on the task similarity 61h and the reference score 61i of the searched model.

When more detailed accuracy prediction for a model is required, the model user presses a prediction accuracy calculation interface display button 611 to display the prediction accuracy calculation interface 62. When the detailed accuracy prediction of the model is not required, the model user downloads the model, presses an evaluation input interface display button 61m, and displays the model user evaluation input interface 63.

### (9) Prediction Accuracy Calculation Interface 62

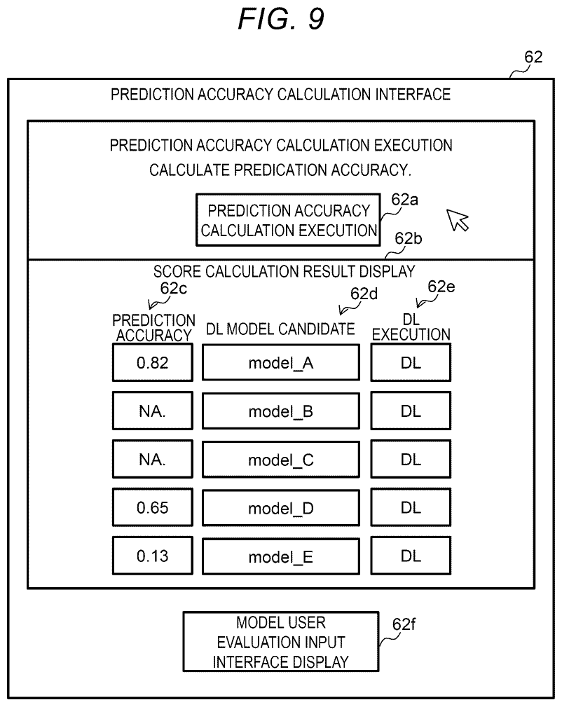

FIG. 9 is a diagram illustrating an example of the prediction accuracy calculation interface 62. The prediction accuracy calculation interface 62 is used for the model user to perform a model search using the model search interface 61 and predict more detailed accuracy of a model displayed as the download candidate model with respect to the model application target data 31.

When a prediction accuracy calculation execution button 62a is pressed, prediction accuracy calculation is executed. In prediction accuracy calculation processing, a model name of the model actual use DB 24 is referred to, data matching a model name of each model displayed on the model search interface 61 is read for each model, and prediction accuracy is calculated for each model.

A prediction accuracy calculation function is used for the prediction accuracy calculation. The prediction accuracy calculation function is determined using, for example, a multiple regression equation such as Formula (3). A similarity weight a, a model pre-evaluation accuracy weight b, and a correction term c in Formula (3) are determined as follows. That is, explanatory variables of the prediction accuracy calculation function are pre-evaluation accuracy of each trained model 11, a similarity between a model pre-evaluation data feature and a model application target data feature, and model accuracy when the trained model 11 searched by the model user is applied to the model application target data. An objective function of the prediction accuracy calculation function is pre-evaluation accuracy of the trained model 11. The similarity weight a, the model pre-evaluation accuracy weight b, and the correction term c are determined according to the least-squares method using the explanatory variables and the objective variable.

When the number of pieces of data indicating matched model names of models is insufficient and model prediction accuracy cannot be calculated, the prediction accuracy is set to “NA”. Calculated prediction accuracy 62c is displayed in a calculation result 62b in a lower part of the prediction accuracy calculation interface 62 together with a model name of a download candidate model 62d.

The model user selects a valid model from a list of model names in the download candidate model 62d based on the prediction accuracy 62c calculated more precisely than the reference score. Then, the model user can start downloading and using the selected model by pressing a download execution button 62e corresponding to the selected model name in the download candidate model 62d. The model user downloads the model and presses a model user evaluation input interface display button 62f to display the model user evaluation input interface 63.

### (10) Model User Evaluation Input Interface 63

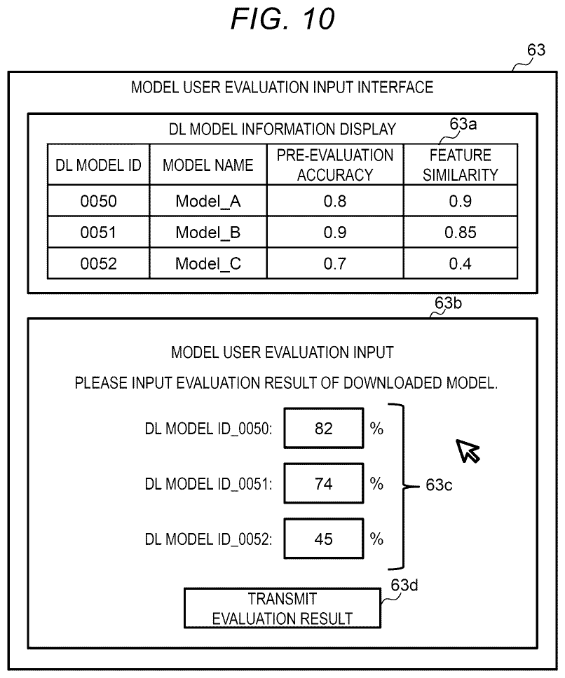

FIG. 10 is a diagram illustrating an example of the model user evaluation input interface 63. The model user evaluation input interface 63 receives an input of a performance evaluation result of the trained model 11 selected and downloaded from the download candidate models 61j and 62d presented by the model search interface 61 and the prediction accuracy calculation interface 62. Then, the model user evaluation input interface 63 transmits the input performance evaluation result to the model management server 200.

The evaluation of the downloaded trained model 11 is executed by the search model performance evaluation unit 38, and performance of the model application target data 31 is evaluated as a model application target. A record ID is assigned to the downloaded trained model 11. In the downloaded trained model 11, the record ID, the model name, and the similarity between the feature of the model pre-evaluation data 13 and the feature of the model application target data 31 are displayed in association with one another for each model in a model information display region 63a of the model user evaluation input interface 63.

When an evaluation result transmission button 63d is pressed after the model user inputs a model evaluation result 63c, a model evaluation result is transmitted. The model evaluation result is transmitted in association with information of each model displayed in the model information display region 63a of the model user evaluation input interface 63, and is stored in the model actual use DB 24 on the model management server 200.

### (11) Model Providing Processing

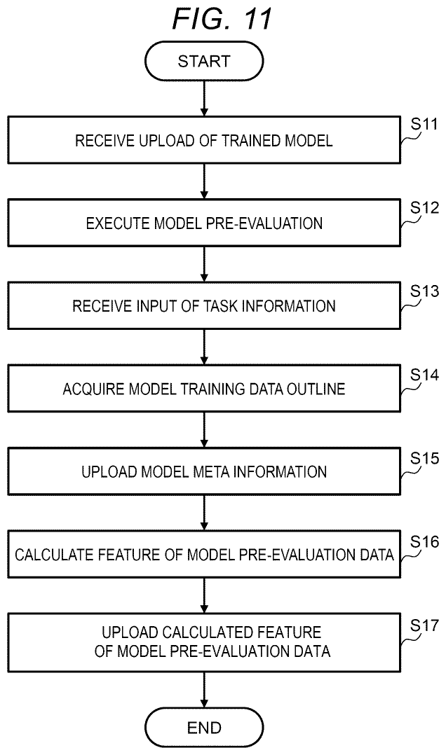

FIG. 11 is a flowchart illustrating an example of model providing processing.

First, in step S11, the model meta information generation unit 15 of the model provider calculation device 100 uploads the model meta information 14 of the trained model 11 to the model management server 200 by operating the model upload interface 51 by a model provider.

Next, in step S12, the model performance pre-evaluation unit 16 of the model provider calculation device 100 executes pre-evaluation on the trained model 11 using the model pre-evaluation data 13 in response to an operation on the model upload interface 51 by the model provider.

Next, in step S13, the task information recording unit 17 of the model provider calculation device 100 receives an input of task information in the natural language related to the use of the trained model 11 in response to an operation on the model upload interface 51 by the model provider.

Next, in step S14, the model training data outline acquisition unit 18 of the model provider calculation device 100 acquires a model training data outline related to the model training data 12 in response to an operation on the model upload interface 51 by the model provider.

Next, in step S15, the model meta information generation unit 15 of the model provider calculation device 100 uploads the model meta information 14 to the model management server 200 in response to an operation on the model upload interface 51 by the model provider. The model meta information generation unit 15 creates the model meta information 14 based on the task information input in step S13 and the model training data outline acquired in step S14.

Next, in step S16, the model pre-evaluation data feature calculation unit 19 of the model provider calculation device 100 calculates a feature of the model pre-evaluation data 13 in response to an operation on the model upload interface 51 by the model provider.

Next, in step S17, the model pre-evaluation data feature calculation unit 19 uploads the feature of the model pre-evaluation data 13 calculated in step S16 to the model management server 200 in response to an operation on the model upload interface 51 by the model provider.

### (12) Sequence from Model Search to Model User Evaluation Input

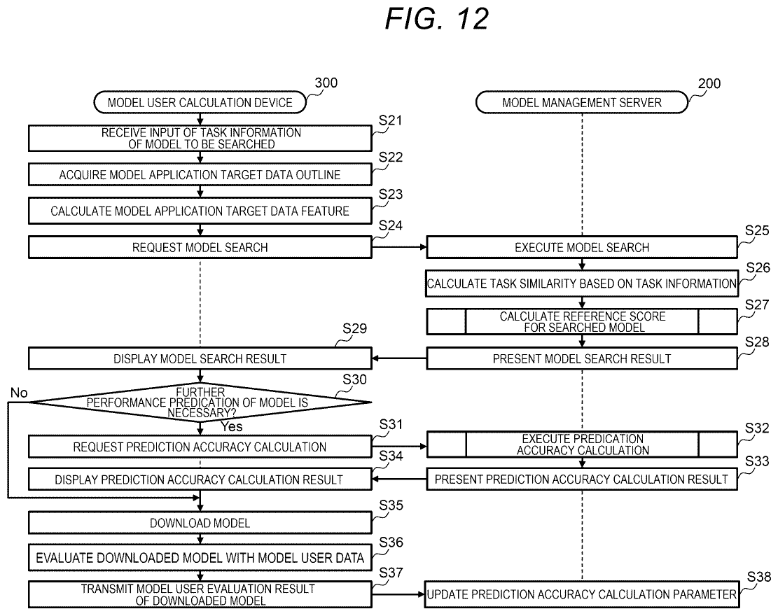

FIG. 12 is a diagram illustrating an example of a sequence from a model search to a model user evaluation input.

First, in step S21, the search model task recording unit 35 of the model user calculation device 300 receives an input of task information of a model to be searched in the natural language in response to an operation on the model search interface 61 by the model user.

Next, in step S22, the model application target data outline acquisition unit 36 of the model user calculation device 300 acquires a model application target data outline in response to an operation on the model search interface 61 by the model user.

Next, in step S23, the model application target data feature calculation unit 37 of the model user calculation device 300 calculates a feature of the model application target data 31 in response to an operation on the model search interface 61 by the model user.

Next, in step S24, the search requirement generation unit 34 of the model user calculation device 300 records the search requirement information 32. The search requirement information 32 is the task information of the model to be searched input in step S21 and the model application target data outline acquired in step S22 in response to an operation on the model search interface 61 by the model user. Then, the search requirement generation unit 34 transmits a request for a model search using the feature of the model application target data 31 calculated in step S23 and the search requirement information 32 to the model management server 200.

Next, in step S25, the model meta information search unit 25 of the model management server 200 executes a model search. That is, the model meta information search unit 25 extracts, from the model meta information DB 22, model meta information having a data outline matching a data outline of a data type and a data size of the model application target data 31 recorded in the search requirement information 32. A model associated with the extracted model meta information is a download candidate model (a candidate for a trained model).

Next, in step S26, the reference score calculation unit 26 of the model management server 200 calculates a similarity between the task information of the model to be searched input in step S21 and task information of the model meta information stored in the model meta information 22 in association with the download candidate model.

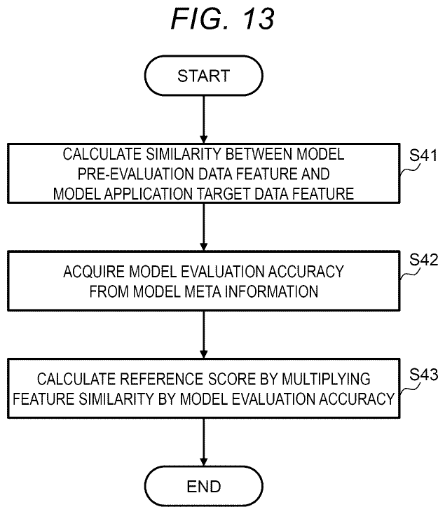

Next, in step S27, the reference score calculation unit 26 calculates a reference score S for each download candidate model based on Formula (1). Details of step S27 will be described later with reference to FIG. 13.

Next, in step S28, the reference score calculation unit 26 transmits the download candidate model searched in step S25, the task information similarity calculated in step S26, and the reference score calculated in step S27 to the model user calculation device 300 as a search result.

Next, in step S29, the search requirement generation unit 34 of the model user calculation device 300 receives the model search result from the model management server 200 and displays the model search result on the model search interface 61.

Next, in step S30, the search requirement generation unit 34 determines whether more precise model accuracy prediction is necessary based on the model search result received from the model management server 200. For example, when there is no large difference in the task similarity or the reference score of the model search result, the model accuracy prediction is determined to be necessary and executed. The model user calculation device 300 proceeds the processing to step S31 when more precise model accuracy prediction is necessary (step S30: Yes), and proceeds the processing to step S35 when the more precise model accuracy prediction is not necessary (step S30: No).

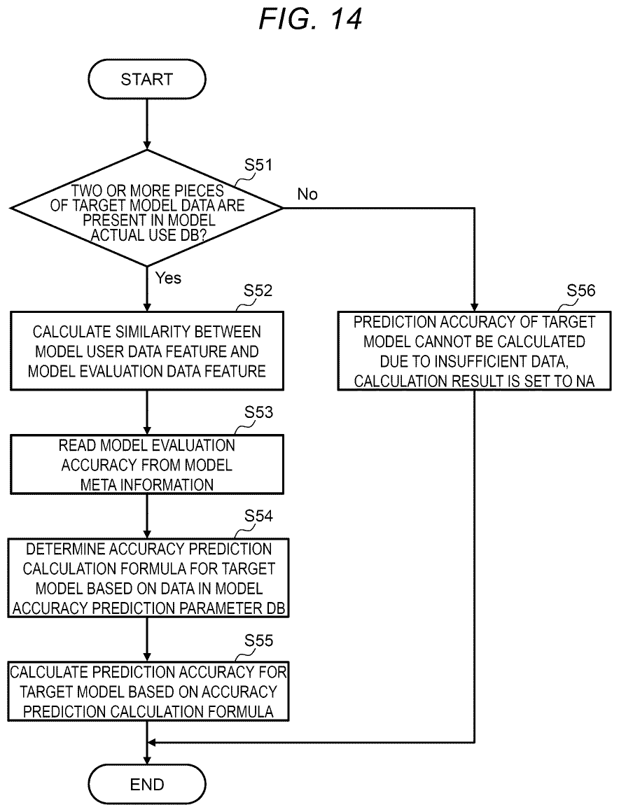

In step S31, the search requirement generation unit 34 requests the model management server 200 to execute prediction accuracy calculation in response to an operation on the prediction accuracy calculation interface 62 by the model user. Next, in step S32, the accuracy prediction unit 27 of the model management server 200 calculates prediction accuracy for each download candidate model. Details of step S32 will be described later with reference to FIG. 14.

Next, in step S33, the accuracy prediction unit 27 transmits the download candidate model and the prediction accuracy calculated in step S32 to the model user calculation device 300 as a prediction accuracy calculation result.

Next, in step S34, the search requirement generation unit 34 of the model user calculation device 300 receives the model prediction accuracy calculation result from the model management server 200, and displays the download candidate model and the prediction accuracy calculation result on the prediction accuracy calculation interface 62.

Next, in step S35, the search requirement generation unit 34 selects the download candidate models 61j and 62d displayed on the model search interface 61 or the prediction accuracy calculation interface 62, and downloads the selected model from the model management server 200.

Next, in step S36, the search model performance evaluation unit 38 of the model user calculation device 300 evaluates performance of the model downloaded in step S35 with respect to the model application target data 31. Next, in step S37, the search model performance evaluation unit 38 inputs a performance evaluation result for the model application target data 31 executed in step S36 in response to an operation on the model user evaluation input interface 63 by the model user. Then, the search model performance evaluation unit 38 transmits the evaluation result to the model management server 200.

Next, in step S38, the model management server 200 receives the performance evaluation result from the model user calculation device 300, and updates the model actual use DB 24 based on the performance evaluation result.

### (13) Flowchart of Reference Score Calculation

FIG. 13 is a flowchart illustrating an example of the reference score calculation. The reference score calculation is executed in step S27 of the sequence from the model search to the model user evaluation input.

First, in step S41, the reference score calculation unit 26 of the model management server 200 calculates a similarity. The similarity calculated here is a similarity between a feature of the model application target data 31 included in a model search request received from the model user calculation device 300 and a feature of the model pre-evaluation data 13 associated with the download candidate model.

Next, in step S42, the reference score calculation unit 26 reads the model meta information 14 associated with the download candidate model from the model meta information DB 22, and acquires a model pre-evaluation accuracy of each download candidate model.

Next, in step S43, the reference score calculation unit 26 calculates a reference score for each download candidate model. The reference score is calculated by multiplying the similarity between the model pre-evaluation data feature of each download candidate model calculated in step S41 and the model application target data feature by the model pre-evaluation accuracy of each download candidate model acquired in step S42.

### (14) Flowchart of Prediction Accuracy Calculation Processing

FIG. 14 is a flowchart illustrating an example of the prediction accuracy calculation processing. The prediction accuracy calculation is executed for each download candidate model in step S32 of the sequence from the model search to the model user evaluation input. In the present embodiment, the similarity weight a, the model pre-evaluation accuracy weight b, and the correction term c are determined for each download candidate model by a multiple regression analysis in Formula (3), and the model prediction accuracy calculation is performed by a multiple regression.

First, in step S51, the accuracy prediction unit 27 of the model management server 200 determines whether the similarity weight the model pre-evaluation accuracy weight b, and the correction term c in the multiple regression analysis can be calculated for each download candidate model based on Formula (3).

When the similarity weight a, the model pre-evaluation accuracy weight b, and the correction term c are determined and the model prediction accuracy calculation is executed by the multiple regression as in the present embodiment, the model pre-evaluation accuracy is constant in the same model. Therefore, an explanatory variable of a regression equation can be regarded as only the similarity between features, and the similarity weight a and the correction term c need to be determined in determination of the regression equation.

Therefore, when two or more pieces of data are accumulated in the model actual use DB 24 for each download candidate model, the similarity weight a and the correction term c can be calculated. Therefore, the accuracy prediction unit 27 determines whether two or more pieces of data are accumulated for each download candidate model. The accuracy prediction unit 27 proceeds the processing to step S52 when two or more pieces of data are accumulated for each download candidate model (step S51: YES), and proceeds the processing to step S56 when two or more pieces of data are not accumulated (step S51: NO).

A regression coefficient of Formula (3) is calculated in the same trained model, so that a and c are calculated from two or more pieces of actual data without considering the right second term “bMA”. When a plurality of trained models are considered, a, b, and c are calculated from three or more pieces of actual data. Therefore, when considering a plurality of trained models, in step S51, a determination condition of “whether three or more pieces of target model data are present in the model actual use DB 24” is used instead of “whether two or more pieces of target model data are present in the model actual use DB 24”.

In step S52, the accuracy prediction unit 27 calculates a similarity between the feature of the model application target data 31 received from the model user calculation device 300 and the feature of the model pre-evaluation data 13 in the model pre-evaluation data feature DB 23 associated with the download candidate model.

Next, in step S53, the accuracy prediction unit 27 reads the model meta information 14 associated with the download candidate model from the model meta information DB 22, and acquires a model pre-evaluation accuracy of each download candidate model.

Next, in step S54, the accuracy prediction unit 27 determines a multiple regression equation for accuracy prediction of Formula (3) using the least-squares method for actual use data corresponding to each download candidate model read from the model actual use DB 24.

Next, in step S55, the accuracy prediction unit 27 calculates prediction accuracy using the multiple regression equation determined in step S54. The similarity between the model pre-evaluation data feature of each download candidate model calculated in step S52 and the model application target data feature, and the model pre-evaluation accuracy of each download candidate model acquired in step S53 are input to the multiple regression equation to calculate the prediction accuracy.

On the other hand, in step S56, since two or more pieces of data corresponding to the download candidate model read from the model actual use DB 24 are not accumulated, the prediction accuracy cannot be calculated, and thus the accuracy prediction unit 27 sets an accuracy calculation result as NA and ends the processing.

### Effects of Embodiment

In the embodiment described above, a score for predicting validity of a candidate of a trained model is calculated based on the model pre-evaluation accuracy and the similarity between the model application target data feature and the model pre-evaluation data feature for pre-evaluating performance of a trained model candidate. Then, the trained model candidate is presented to a model user together with the score. Therefore, according to the embodiment, it is not necessary to transmit and receive sensitive information such as sample data and simulation data between devices via a network in order to verify performance of a model at the time of a model search, and information leakage is prevented. It is possible to provide a trained model which is valid for a model user and which is suitable for the model application target data. In addition, since it is not necessary to transmit and receive sample data, simulation data, and the like between devices via a network, it is possible to reduce a communication load of the network.

In the embodiment described above, a prediction model for calculating prediction accuracy for predicting validity of the trained model candidate is generated based on the model user evaluation accuracy, the similarity between the features of the data for learning and evaluation described above, and the model pre-evaluation accuracy. The model user evaluation accuracy is an evaluation result of a model when the trained model candidate is applied to the model application target data. Therefore, according to the embodiment, it is possible to more appropriately determine the validity of the trained model candidate based on higher prediction accuracy according to an actual operation of the trained model.

In the embodiment described above, the prediction model is generated by a regression analysis based on the model user evaluation accuracy described above, the similarity between the features of the data for learning and evaluation described above, and the model pre-evaluation accuracy. Therefore, the prediction model can be generated by relatively simple calculation.

In the embodiment described above, the prediction model is generated by a neural network based on the model user evaluation accuracy described above, the similarity between the features of the data for learning and evaluation described above, and the model pre-evaluation accuracy. Therefore, the prediction accuracy can be improved by using a prediction model with higher performance.

In the embodiment described above, a data outline including a type and a data size of the model application target data is acquired, and the trained model candidate is selected from a plurality of trained models based on the data outline. In addition, the trained model candidate is selected from a plurality of trained models based on task information related to use of the trained model candidate that is a search target input by a model user. Therefore, information leakage can be prevented since it is not necessary to transmit and receive sensitive information such as sample data and simulation data when selecting the trained model candidate, and a communication load on a network can be reduced.

### Hardware Configuration of Computer 1000

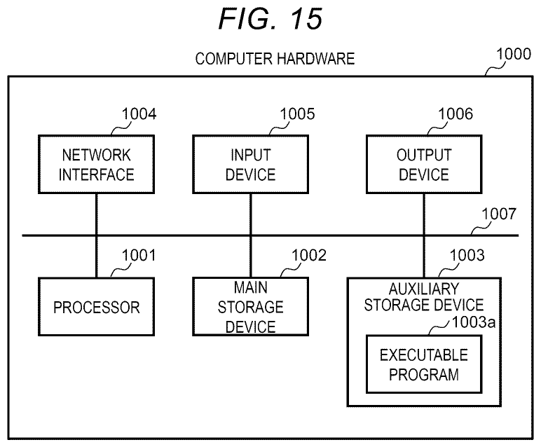

FIG. 15 is a diagram illustrating a hardware configuration example of a computer 1000. The computer 1000 implements units of the model provider calculation device 100, the model management server 200, and the model user calculation device 300 of the model search system 1 by executing predetermined programs.

The computer 1000 includes a processor 1001 that is typically a CPU, a main storage device 1002, an auxiliary storage device 1003, a network interface 1004, an input device 1005, and an output device 1006, which are connected to one another via an internal communication line 1007 such as a bus.

The processor 1001 controls an overall operation of the computer 1000. The main storage device 1002 is implemented by, for example, a volatile semiconductor memory, and is used as a work memory of the processor 1001. The auxiliary storage device 1003 includes a large-capacity nonvolatile storage device such as a hard disk device, a solid state drive (SSD), or a flash memory, and is used to store various programs and data for a long period of time.

An executable program 1003a stored in the auxiliary storage device 1003 is loaded into the main storage device 1002 when the computer 1000 is started or when necessary, and is executed by the processor 1001.

The executable program 1003a may be recorded in a non-transitory recording medium, read from the non-transitory recording medium by a medium reading device, and loaded into the main storage device 1002. Alternatively, the executable program 1003a may be acquired from an external computer via a network and loaded into the main storage device 1002.

The auxiliary storage device 1003 stores various executable programs 1003a.

The network interface 1004 is an interface device for connecting the computer 1000 to a network in a system or communicating with other computers. The network interface 1004 includes, for example, a network interface card (NIC) such as a wired local area network (LAN) or a wireless LAN.

The input device 1005 includes a keyboard and a pointing device such as a mouse, and is used by a user to input various instructions and information to the computer 1000. The output device 1006 includes, for example, a display device such as a liquid crystal display or an organic electro luminescence (EL) display, and an audio output device such as a speaker, and is used to present necessary information to a user when necessary.

The invention is not limited to the embodiments described above, and includes various modifications. For example, the embodiments described above have been described in detail to facilitate understanding of the invention, and the invention is not necessarily limited to those including all the configurations described above. A part of a configuration according to a certain embodiment can be replaced with a configuration according to another embodiment, and a configuration according to another embodiment can be added to a configuration according to a certain embodiment. In addition, another configuration can be added to, deleted from, or replaced with a part of a configuration of each embodiment.

Distribution and integration of functions of the model provider calculation device 100, the model management server 200, and the model user calculation device 300 include various forms. For example, there is a form in which the model management server 200 only proposes an optimal trained model to a model user based on index information such as a feature, and actual transfer of the trained model is directly performed between the model provider calculation device 100 and the model user calculation device 300. For example, the model management server 200 and the model user calculation device 300 may be integrated.

What is claimed is:

1. An information processing system that selects a valid trained model candidate from a plurality of trained models and presents the selected trained model candidate to a model user, the information processing system comprising:
a model management server; and
a model user calculation device configured to be operated by the model user, wherein
the model management server stores, in a storage unit, the plurality of trained models, a model pre-evaluation data feature that is a feature of model pre-evaluation data for pre-evaluating performance of the plurality of trained models, and model pre-evaluation accuracy that is model accuracy of the plurality of trained models pre-evaluated based on the model pre-evaluation data,
the model user calculation device
stores, in a storage unit, model application target data that is an application target of the trained model candidate selected from the plurality of trained models,
calculates a model application target data feature that is a feature of the model application target data, and
transmits the calculated model application target data feature to the model management server, and
the model management server
calculates a similarity between the model pre-evaluation data feature and the model application target data feature received from the model user calculation device,
calculates a score for predicting validity of the trained model candidate based on the similarity and the model pre-evaluation accuracy, and
presents the score together with the trained model candidate to the model user via the model user calculation device.

2. The information processing system according to claim 1, wherein
the model user calculation device
receives, as model user evaluation accuracy, a model evaluation result when the trained model candidate input by the model user is applied to the model application target data, and
transmits the received model user evaluation accuracy to the model management server, and
the model management server
generates a prediction model for calculating prediction accuracy for predicting the validity of the trained model candidate based on the model user evaluation accuracy received from the model user calculation device, the similarity, and the model pre-evaluation accuracy,
calculates the prediction accuracy based on the model user evaluation accuracy, the similarity, the model pre-evaluation accuracy, and the prediction model, and
presents the score and the prediction accuracy together with the trained model candidate to the model user via the model user calculation device.

3. The information processing system according to claim 2, wherein
the model management server generates the prediction model by a regression analysis based on the model user evaluation accuracy, the similarity, and the model pre-evaluation accuracy.

4. The information processing system according to claim 2, wherein
the model management server generates the prediction model by a neural network based on the model user evaluation accuracy, the similarity, and the model pre-evaluation accuracy.

5. The information processing system according to claim 1, wherein
the model user calculation device
acquires a data outline including a type and a data size of the model application target data, and
transmits the acquired data outline to the model management server, and
the model management server selects the trained model candidate from the plurality of trained models based on the data outline.

6. The information processing system according to claim 5, wherein
the model user calculation device
receives task information related to use of the trained model candidate that is a search target input by the model user, and
transmits the received task information to the model management server, and
the model management server selects the trained model candidate from the plurality of trained models based on the task information and the data outline received from the model user calculation device.

7. An information processing method for an information processing system to select a valid trained model candidate from a plurality of trained models and present the selected trained model candidate to a model user, wherein
the information processing system includes a model management server, and a model user calculation device configured to be operated by the model user,
the information processing method comprising:
storing, by the model management server, in a storage unit, the plurality of trained models, a model pre-evaluation data feature that is a feature of model pre-evaluation data for pre-evaluating performance of the plurality of trained models, and model pre-evaluation accuracy that is model accuracy of the plurality of trained models pre-evaluated based on the model pre-evaluation data;
storing, by the model user calculation device, in a storage unit, model application target data that is an application target of the trained model candidate selected from the plurality of trained models;
calculating, by the model user calculation device, a model application target data feature that is a feature of the model application target data;
transmitting, by the model user calculation device, the calculated model application target data feature to the model management server;
calculating, by the model management server, similarity between the model pre-evaluation data feature and the model application target data feature received from the model user calculation device;
calculating, by the model management server, a score for predicting validity of the trained model candidate based on the similarity and the model pre-evaluation accuracy; and
presenting, by the model management server, the score together with the trained model candidate to the model user via the model user calculation device.
